(19) United States
(12) Patent Application Publication
(10) Pub. No.: US 2009/0239401 A1
(43) Pub. Date: Sep. 24, 2009

(54) Conductor Track Carrier

(75) Inventors: Martin Fink, Lauterhofen (DE); Christian Janisch, Burglengenfeld (DE); Karl Smirra, Wasserburg (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/299,387

(22) PCT Filed: Jan. 17, 2007
(86) PCT No.: PCT/EP2007/050464

§ 371 Date: Nov. 3, 2008

(30) Foreign Application Priority Data
May 5, 2006 (DE) 10 2006 021 096.4

(51) Int. Cl. H01R 4/58

(52) U.S. Cl. 439/214

(57) ABSTRACT

A conductor track carrier is intended to contact-connect electrical components. The carrier has a flexible base film, a conductor track on the base film, and a contact-connection eye arranged in a contact-connection section of the conductor track carrier and electrically coupled to the conductor track. The conductor track carrier has a respective recess on two opposite sides of the contact-connection section, and web elements formed between the recesses in such a manner that the contact-connection section is pivotably mounted.

The invention relates to a conductor track carrier intended to contact-connect electrical components.

In the case of motor vehicles there is an increasingly frequent requirement to integrate a control electronics unit and the associated sensors in an automatic gearbox. This type of integration is also increasingly desirable with regard to the control of engines and braking systems. Flexible printed circuit boards or flexible films are frequently used here in the mechatronic systems employed in this situation. For economic reasons these printed circuit boards are implemented as single-layer printed circuit boards. The control electronics mounted on a circuit carrier must be screened against the oils, which contain highly aggressive chemical additives, used in the engines and gearboxes. At the same time however, electrical lines need to be taken through the screen in order to enable electronic control of components of an engine or a gearbox. Technological system requirements ensue in particular in respect of impermeability to the ambient media (oil, gasoline, water), the functional capability over a wide temperature range (−40° C. to +140° C.) and resistance to vibration acceleration effects.

A control device for a motor vehicle is known from the published patent application DE 199 07 949 A1. A flexible film carrying conductor tracks surrounds an electronic circuit which is located in a cavity in a housing. The flexible printed circuit board is taken through from the cavity between a ring seal and a metallic base plate of the control device and is itself part of the sealing system for the housing.

In the German patent application DE 199 61 116 A1 a printed circuit board arrangement with a single-layer printed circuit board and a circuit carrier associated with the printed circuit board is described, in particular for a control device in a motor vehicle. Sensors, actuators and connectors of the engine and/or gearbox control device are connected to electronic and/or electrical components of a control circuit on a circuit carrier by means of the flexible printed circuit boards.

The object of the invention is to create a conductor track carrier intended to contact-connect electrical components, which enables a cost-effectively implementable and mechanically reliable electrical connection of electrical components on the conductor track carrier.

This object is achieved by the features of the independent claims. Advantageous embodiments of the invention are set down in the subclaims.

The invention is characterized by a conductor track carrier intended to contact-connect electrical components, having a flexible base film, a conductor track arranged on the base film, and a contact-connection eye which is arranged in a contact-connection section of the conductor track carrier and is electrically coupled to the conductor track, whereby the conductor track carrier has a respective recess on two opposite sides of the contact-connection section, and web elements are formed between the recesses in such a manner that the contact-connection section is pivotably mounted.

This is particularly advantageous since use of the pivotable mounting for the contact-connection section means that good tolerance equalization is possible between the conductor track carrier and the electrical components to be contact-connected with regard to assembly of the electrical components on the conductor track carrier. This therefore means that the electrical components can be secured on the conductor track carrier in a simple but nevertheless stable manner.

In a particularly preferred embodiment of the invention, the conductor track carrier has at least two contact-connection sections each having two contact-connection eyes, and in each case one of the contact-connection eyes of each contact-connection section is electrically coupled to a common conductor track. This makes it possible to achieve an especially low space requirement for the conductor track carrier since, in the case of an embodiment of a plurality of conductor tracks instead of one common conductor track, gaps between the conductor tracks are required, which are avoided by using the common conductor track. Furthermore, it is thus possible to avoid detours and crossovers in the conductor track routing.

In a further particularly preferred embodiment of the invention, the web elements of each contact-connection section are arranged on two opposite sides of the respective contact-connection section and each of the conductor tracks coupled in each case to a contact-connection eye of the respective contact-connection section is arranged individually in each case on a section by section basis on one of the web elements situated opposite one another. By this means an essentially symmetrical and for this reason particularly uniformly geometric design of the web elements can be achieved.

Particularly when pivoting the contact-connection section, a uniform mechanical loading of the web elements is thus possible. In addition, the individual conductor tracks can be spaced apart from one another particularly easily on account of their arrangement on the web elements situated opposite one another.

In a further particularly preferred embodiment of the invention, the recesses have a partial ring shape. As a result, only a small space requirement is needed for the recesses, by which means the overall size of the conductor track carrier can be kept small.

Advantageous embodiments of the invention will be described in detail in the following with reference to the schematic drawings. In the drawings:

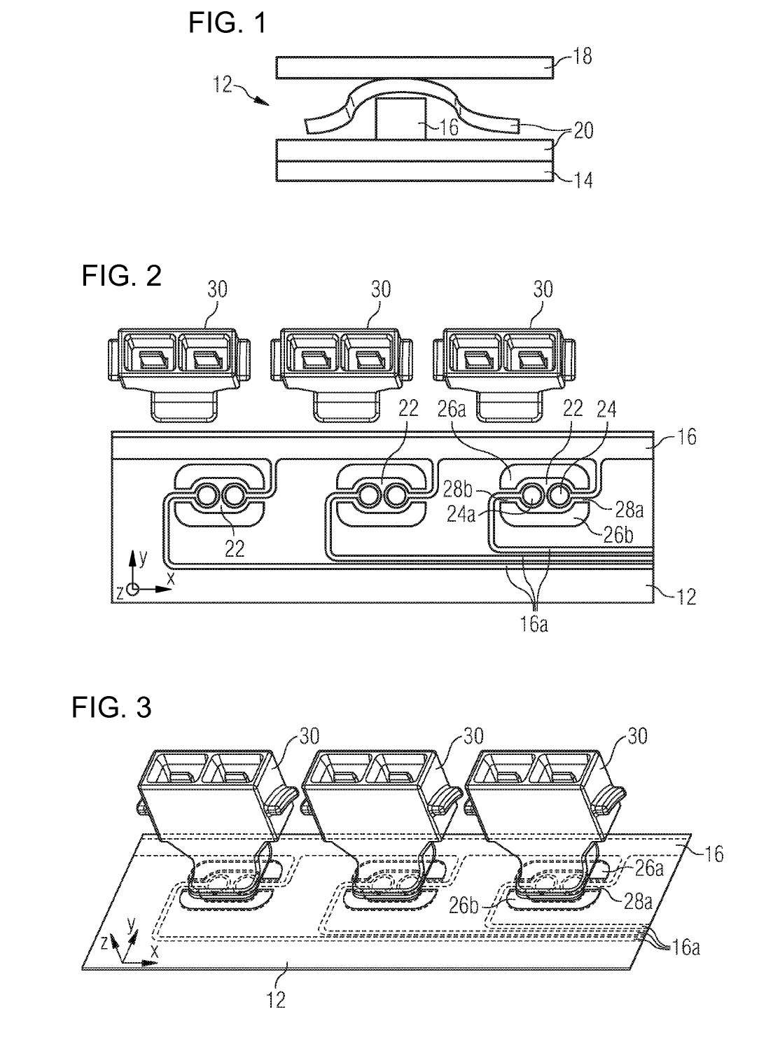

FIG. 1 shows a sectional view of a conductor track carrier,

FIG. 2 shows a top view of the conductor track carrier with electrical components provided for contact connection, and

FIG. 3 shows a perspective view of the conductor track carrier with contact-connected electrical components.

Elements having the same construction or the same function are identified by the same reference characters in all the figures.

The sectional view shown in FIG. 1 illustrates the structure of a conductor track carrier 12. A conductor track 16, which is preferably composed of copper, is arranged between a base film 14 and a covering film 18. The conductor track 16 is embedded in different adhesive layers 20 which are arranged between the base film 14 and the conductor track 16 on the one hand and the conductor track and the covering film 18 on the other hand. Both the base film 14 and also the covering film 18 are flexible and are preferably composed of polyimide which exhibits the requisite chemical, thermal and mechanical properties for use in motor vehicle components.

FIGS. 2 and 3 show views of the conductor track carrier 12 and of electrical components 30 which have been readied for mounting (FIG. 2) and have been mounted (FIG. 3). The electrical components 30 here are electrical connector elements. Other electrical components, such as sensors for example, can however also be used.

As can be seen from FIGS. 2 and 3, the conductor track carrier 12 accommodates a plurality of conductor tracks 16, 16a. The conductor track carrier 12 has a plurality of contact-connection sections 22, each of which has two contact-connection eyes 24, 24a. It is however also possible for the contact-connection sections 22 to have only one contact-connection eye 24 or more than two contact-connection eyes 24, 24a, depending on how the electrical component 30 to be contact-connected is designed.

In addition, the conductor track carrier 12 has partially ring-shaped recesses 26a, 26b which are arranged in each case on two opposite sides of a contact-connection section 22. Between the recesses 26a, 26b on the conductor track carrier 12 remain web elements 28a, 28b which are situated opposite one another on two sides of the contact-connection section 22.

One of the conductor tracks 16a passes by way of one of the web elements 28b in each case from the contact-connection eyes 24a on the contact-connection sections 22. The conductor tracks 16a are preferably coupled electrically to a circuit carrier, not shown, in particular an LTCC substrate (LTCC=low temperature cofired ceramics). Conductor track sections lead in each case from the contact-connection eyes 24 by way of the web elements 28a to the common conductor track 16. This is preferably implemented as a ground connection. By implementing the conductor track 16 as a common conductor track it is possible to reduce the surface area of the conductor track carrier 12.

In the following, the mode of operation of the conductor track carrier 12 will be described in detail in conjunction with the assembly of the electrical components 30. It is also assumed here by way of example that the electrical components 30 are connector elements.

Furthermore, it is additionally assumed that connector elements are used for the contact-connection of gearbox hydraulic valves for a shift gearbox of a motor vehicle. The gearbox hydraulic valves are arranged in more or less a straight line in the shift gearbox.

In order to achieve as rapid assembly as possible when assembling the gearbox hydraulic valves on the connector elements, the connector elements should allow a tolerance equalization in all three coordinate directions. The tolerance equalization in the z-direction is effected by means of a suitable overlap length between the connector element and an associated mating connector on the gearbox hydraulic valve. The connector elements can compensate for a tolerance equalization in the x-direction compared to the mating connectors of the gearbox hydraulic valve on account of the existing tolerances of the connector elements or of the mating connectors.

Since the connector elements sit on the contact-connection sections 22 and the contact-connection sections 22 are coupled only by way of the web elements 28a, 28b with the other areas of the conductor track carrier 12 the contact-connection section 22 can be pivoted together with the connector element, whereby the swivel axis passes through the two web elements 28a, 28b. As a result of the arrangement of the web elements 28a, 28b in the swivel axis, the conductor tracks 16a, 16 are subject to only a small mechanical stress when the connector is pivoted. On account of the constructional height of the connector elements, the tolerance equalization between connector element and mating connector in the y-direction required for the assembly can already be achieved at a small pivoting angle (of 4 degrees for example).

A further advantage during manufacture and assembly consists in the fact that the conductor track carrier 12 does not need to be bent in order to fix the electrical components 30 because all the contact-connection sections 22 lie in one plane, the plane of the conductor track carrier 12. The electrical components 30 can thus be contact-connected in a clamping arrangement on the conductor track carrier 12, whereby the contact-connection can take place in one working plane, by means of laser welding for example.

1-4. (canceled)

5. A conductor track carrier for contact-connecting electrical components, comprising:
a flexible base film;
a conductor track formed on said base film; and
a contact-connection eye disposed in a contact-connection section of the conductor track carrier and electrically connected to said conductor track;
the conductor track carrier having a respective recess formed therein on two opposite sides of the contact-connection section; and
web elements formed between said recesses for mounting the contact-connection section pivotally.

6. The conductor track carrier according to claim 5, comprising at least two contact-connection sections each having two contact-connection eyes, and wherein one of said contact-connection eyes of each contact-connection section is electrically coupled to a common conductor track.

7. The conductor track carrier according to claim 6, wherein said web elements of each contact-connection section are disposed on two opposite sides of the respective contact-connection section and each of said conductor tracks coupled in each case to a contact-connection eye of the respective said contact-connection section is arranged individually in each case on a section by section basis on one of the web elements situated opposite one another.

8. The flexible conductor track carrier according to claim 5, wherein said recesses have a partial ring shape.
